(19) United States
(12) Patent Application Publication
(10) Pub. No.: US 2012/0145038 A1
(43) Pub. Date: Jun. 14, 2012

(54) CLAY DISPERSION LIQUID, AND METHOD FOR PRODUCING THE SAME, CLAY FILM, AND METHOD FOR PRODUCING THE SAME, AND TRANSPARENT MATERIAL

(75) Inventors: Hajime Tsuda, Shizuoka-shi (JP); Katsumi Motegi, Shizuoka-shi (JP); Yusuke Takechi, Shizuoka-shi (JP); Kazunori Kawasaki, Sendai-shi (JP); Takeo Ebina, Sendai-shi (JP); Fujio Mizukami, Tsukuba-shi (JP)

(73) Assignee: Tomoegawa Co., Ltd., Chuo-ku, Tokyo (JP)

(21) Appl. No.: 13/391,881

(22) PCT Filed: Aug. 24, 2010
(86) PCT No.: PCT/JP2010/064235

§ 371 Date: Feb. 23, 2012

(30) Foreign Application Priority Data
Aug. 26, 2009 (JP) 2009-195070
Aug. 26, 2009 (JP) 2009-195167

(51) Int. Cl. C09D 1/00; B28B 13/02

(52) U.S. Cl. 106/287.17; 106/287.19; 264/212

(57) ABSTRACT

An object of the present invention is to provide a clay dispersion liquid which is capable of obtaining a clay film which realizes compatibility between heat resistance and water resistance, and a method for producing the same; a clay film and a transparent material, produced from the lay dispersion. The clay dispersion liquid of the present invention contains a liquid containing water as a main component, and a tetraphenylphosphonium-modified clay. The clay film and the transparent material of the present invention are obtained by applying the clay dispersion liquid on a surface of a supporting body to form a film.

### TECHNICAL FIELD

The present invention relates to a tetraphenylphosphonium-modified clay dispersion liquid, and a method for producing the same, and a clay film, and a method for producing the same. More particularly, the present invention relates to a clay film having excellent heat resistance and water resistance, and a clay dispersion liquid for obtaining the film. Furthermore, the present invention provides a transparent material having a mechanical strength enabling its use as an independent film, flexibility and water resistance in which a lamination layer of inorganic layered compound particles is highly oriented.

### BACKGROUND ART

Clay typified by smectite forms a clay film, in which flaky particles are arranged in a layered form, by dispersing the clay in water and then drying the dispersion of the clay while being left to stand. The clay film having flexibility has excellent heat resistance since it is made of an inorganic substance. Furthermore, due to the layered arrangement, the maze effect is exerted thus making it possible to form an independent film which has high gas barrier property and also can exist as a film by itself even after being separated from a base material.

Accordingly, intense interest has recently been shown towards use of such a clay film as a flexible substrate usable for display devices or solar cells, because of excellent gas barrier property and heat resistance thereof (refer to Patent Literature 1).

However, ions such as sodium ions having high hydrophilicity exist on a surface of the clay. Therefore, it is easy for water to penetrate into a clay film obtained from the clay, and the clay film has not water resistance. Accordingly, it is difficult to use the clay film as an industrial material because the clay film is dissolved when immersed in water and it cannot hold its shape.

It is known that use of an organically modified clay, in which hydrophilic ions existing on a surface of the clay have been exchanged with organic ions, is useful so as to prevent water from penetrating into the clay film (refer to Patent Literature 2).

The organically modified clay is generally produced by a method in which ion-exchange between organic ions and hydrophilic ions existing on the surface of clay is performed and then the ion-exchanged swelling clay is subjected to the washing, drying and grinding steps to obtain a powdered clay. In order to form a clay film using the organically modified clay, the organically modified clay must be dispersed in an organic solvent. The degree of dispersion of the obtained organically modified clay in the organic solvent varies depending on the number of carbon atoms and the amount of aromatic rings contained in organic ions used in ion-exchange with the hydrophilic ions. When the amount of aromatic rings is too large and the carbon content is too small, it becomes difficult to disperse the organically modified clay in the organic solvent. However, when organic ions have no aromatic ring and the carbon content is too large, there arises a problem that heat resistance, which is a feature of the organic modified clay, deteriorates by all means. There has recently been produced a clay film in which an organically modified clay produced by performing ion-exchange by an ionic liquid is used. However, the heat resistance and thermolysis temperature are about 300° C. at most (see Patent Literatures 3 and 4).

A display device has been quickly changed to a liquid crystal type display (LCD) device from a conventional Braun tube type display device from the viewpoint of mobility and space saving. Furthermore, the production of an organic EL type display device which is a spontaneous light emitting device and is also excellent in brightness, vividness and power consumption, as a next' generation display, has started. The organic EL type display device is noticeably excellent in mobility and space saving as compared with a conventional Braun tube type display device. However, since glass is used as a substrate, it has a problems such as comparatively large weight and the occurrence of fracture.

In order to solve these problems, a film substrate (called a plastic cell) is used in a partial liquid crystal type display device. However, in case of an organic EL display device which comes to attract attention as the next generation display device, a transparent conductive film with low resistance is required. In order to obtain a transparent conductive film with low resistance, sintering by a heat treatment of more than 250° C. is indispensable. Also, use of a film substrate, which is lightweight and is less likely to be fractured as compared with a glass substrate, as a solar cell panel has attracted special interest. In this case, other than transparency and weatherability, requirements for heat resistance has increased. However, a conventional plastic substrate does not satisfy these characteristics. A transparent clay thin film has attracted special interest as a material which can satisfy these requirements.

### CITATION LIST

### Patent Literature

[Patent Literature 1]

Japanese Patent No. 3,855,003
[Patent Literature 2]

Japanese Unexamined Patent Application, First Publication No. 2007-84386
[Patent Literature 3]

Japanese Unexamined Patent Application, First Publication No. 2008-266124
[Patent Literature 4]

Japanese Unexamined Patent Application, First Publication No. 2009-137833

### SUMMARY OF INVENTION

Under these circumstances, the present invention has been made and an object thereof is to provide a clay dispersion liquid which is capable of obtaining a clay film which realizes compatibility between heat resistance and water resistance, and a method for producing the same, a clay film produced from the clay dispersion liquid, and a transparent material using the clay film.

### Solution to Problem

The present inventors have intensively studied based on the above object and thus the present invention has been completed with the following technical constitutions.
(1) A clay dispersion liquid including:

a liquid containing, as a main component, a polar solvent containing water; and

a tetraphenylphosphonium-modified clay.
(2) The clay dispersion liquid according to the above (1), which is obtained by:

introducing tetraphenylphosphonium ions into a liquid containing, as a main component, water containing a clay dispersed therein to thereby perform ion-exchange between hydrophilic cations existing in the clay and the tetraphenylphosphonium ions to obtain a tetraphenylphosphonium-modified clay;

adding a first polar solvent to the tetraphenylphosphonium-modified clay to thereby remove the by-produced electrolyte; and

adding a second polar solvent to the tetraphenylphosphonium-modified clay in a state of containing the first polar solvent to thereby disperse the tetraphenylphosphonium-modified clay.
(3) The clay dispersion liquid according to the above (2), wherein the clays are one more kinds selected from the group consisting of kaolinite, dickite, halloysite, chrysotile, lizardite, amesite, pyrophyllite, talc, montmorillonite, beidellite, nontronite, stevensite, saponite, hectorite, sauconite, two-octahedron type vermiculite, three-octahedron type vermiculite, muscovite, paragonite, illite, sericite, phlogopite, biotite, lepidolite, magadiite, ilerite, kanemite and layered titanic acid.
(4) The clay dispersion liquid according to the above (2), wherein the first polar solvent contains at least one of water, acetonitrile, ethanol, methanol, propanol and isopropanol.
(5) The clay dispersion liquid according to the above (2), wherein the second polar solvent contains at least one of water, N,N-dimethylformamide, dimethylacetamide, dimethyl sulfoxide and 1-methyl-2-pyrrolidone.
(6) A method for producing a clay dispersion liquid, containing:

the first step of dispersing clay in a liquid containing water as a main component to obtain a dispersion;

the second step of introducing tetraphenylphosphonium ions into the dispersion to thereby perform ion-exchange between hydrophilic cations existing in the clay and the tetraphenylphosphonium ions to obtain a tetraphenylphosphonium-modified clay, and adding a first polar solvent to the tetraphenylphosphonium-modified clay to thereby remove the by-produced electrolyte to obtain a dispersion containing the first polar solvent; and

the third step of adding a second polar solvent to the tetraphenylphosphonium-modified clay in the dispersion containing the first polar solvent to thereby disperse the tetraphenylphosphonium-modified clay in a mixed solvent of the first and second polar solvents to obtain a clay dispersion liquid.
(7) A clay film which is obtained by:

applying the clay dispersion liquid according to any one of the above (1) to (5) onto a base material, or pouring the clay dispersion liquid into a container;

removing a liquid containing, as a main component, a polar solvent containing water in the clay dispersion liquid to form a film; and

removing the film from the base material or the container.
(8) The clay film according to the above (7), wherein a moisture absorption rate at 40° C. and a relative humidity of 90% is less than 5%.
(9) A method for producing a clay film, which includes the steps of:

applying the clay dispersion liquid according to any one of the above (1) to (5) on a surface of a supporting body having a flat surface;

removing a dispersion medium in the dispersion to form a film on the supporting body; and

removing the film from the supporting body.
(10) A transparent material including the clay film according to the above (7) or (8), wherein a total light transmittance (JIS K7105: 1981) is more than 80%.
(11) The transparent material according to the above (10), wherein a light transmittance at 500 nm is 80% or more.
(12) The transparent material according to the above (10), wherein the light transmittance at 500 nm is 70% or more after heating at 400° C. under atmospheric condition.

### Effects of the Invention

According to the present invention, it is possible to provide a clay dispersion liquid which is capable of obtaining a clay film which realizes compatibility between heat resistance and water resistance, and a method for producing the same, a clay film produced from the clay dispersion liquid, and a transparent material using the clay film.

### BRIEF DESCRIPTION OF DRAWINGS

FIG. 1 is a graph showing visible-ultraviolet absorption spectra of a transparent material (TPP-SA) of the present invention after heating at 200° C., 300° C., 350° C. and 400° C.

FIG. 2 is a graph showing an X-ray diffraction chart of a transparent material (TPP-SA) of the present invention.

FIG. 3 is a scanning electron micrograph of a cross section of a transparent material (TPP-SA) of the present invention.

FIG. 4 is a graph showing visible-ultraviolet absorption spectra of a transparent material (TPP-HE-SA) of the present invention after heating at 200° C., 300° C., 350° C. and 400° C.

FIG. 5 is a graph showing an X-ray diffraction chart of a transparent material (TPP-HE-SA) of the present invention.

FIG. 6 is a scanning electron micrograph of a cross section of a transparent material (TPP-HE-SA) of the present invention.

### DETAILED DESCRIPTION OF THE EMBODIMENTS

Preferred Examples of the present invention will be described in detail below.

### (Clay Dispersion Liquid)

A clay dispersion liquid of the present invention can be obtained as described below. Tetraphenylphosphonium ions are introduced into a liquid containing water as a main component, in which clay is dispersed to thereby perform ion-exchange between hydrophilic cations existing in the clay and the tetraphenylphosphonium ions to obtain a tetraphenylphosphonium-modified clay. Thereafter, the ion-exchanged hydrophilic cations (by-produced electrolyte) are separated using a first polar solvent, and then the tetraphenylphosphonium—modified clay in a state of containing a first polar solvent is added to a second polar solvent, and thus a dispersion containing the tetraphenylphosphonium-modified clay dispersed therein can be obtained.

In the present invention, the hydrophilic cations existing in the clay means that the hydrophilic cations exist in at least one of a surface of the clay or spacing between layers.

### (Clay)

There is no particular limitation on the clay which is used in the clay dispersion liquid of the present invention, and the clay can be optionally selected. For example, clay made of a natural or synthetic substance can be exemplified. Specifically, the clay is preferably one or more kinds selected from the group consisting of kaolinite, dickite, halloysite, chrysotile, lizardite, amesite, pyrophyllite, talc, montmorillonite, beidellite, nontronite, stevensite, saponite, hectorite, sauconite, two-octahedron type vermiculite, three-octahedron type vermiculite, muscovite, paragonite, illite, sericite, phlogopite, biotite, lepidolite, magadiite, ilerite, kanemite and layered titanic acid. Among these clays, hectorite, stevensite, saponite, and montmorillonite are particularly preferable since they have high swellability and have the grain diameter in nanometer order, and also show a flat form. Therefore, they are easily oriented by self-organization, and also they are easily available. These clays may be used alone or in combination.

When transparency is required for the clay film, a synthetic clay is preferably used. Since the synthetic clay contains less impurities as a cause of coloration and has small grain diameter as compared with a natural clay, transparency is imparted to the film using the synthetic clay.

Depending on the kind of the clay, characteristics of the film after film formation vary. For example, the obtained film has satisfactory flexibility, or the obtained film is excellent in transparency. In order to obtain desired film characteristics, characteristics of the film after film formation can be variously adjusted by using various clays in combination. For example, the synthetic saponite enables formation of a film which is excellent in flexibility, but is slightly inferior in transparency, while the synthetic hectorite enables formation of a film which is excellent in transparency, but is slightly inferior in flexibility. Mixing of these clays in a predetermined ratio enables formation of a film which is flexible and is also excellent in transparency. When it is desired to impart flexibility and transparency to the claim film after film formation, the mass ratio of the synthetic saponite to the synthetic hectorite is preferably adjusted to be within a range of from 80/20 to 20/80, and more preferably from 60/40 to 40/60.

### (Tetraphenylphosphonium Ions)

Tetraphenylphosphonium ions are used as ions to be ion-exchanged with hydrophilic ions existing in clay in the clay dispersion liquid of the present invention. In cases where ammonium ions and imidazolium ions are used as organoonium ions in place of tetraphenylphosphonium ions in the present invention, or in both cases where a substituent existing adjacent to an atom having plus charges contains a carbon-containing substituent other than a phenyl group, and a phenyl group is not used for all substituents, the obtained clay film exhibits a thermolysis initiation temperature of 300° C. or lower and its effect is inferior to that of the case of using tetraphenylphosphonium ions in the present invention.

The clay dispersion liquid of the present invention is not limited as long as the thermolysis initiation temperature of the clay film obtained using the clay dispersion liquid becomes higher than 300° C. It is not necessary that ions capable of exiting in the clay constituting the clay dispersion liquid are only composed of tetraphenylphosphonium ions. Therefore, for example, ammonium ions, imidazolium ions and phosphonium ions may exist, as organoonium ions, in addition to tetraphenylphosphonium ions in the clay. Also, hydrophilic ions may exist (remain) in the tetraphenylphosphonium-modified clay.

### (First Polar Solvent)

There is no particular limitation on the first polar solvent used in the present invention, as long as it can remove cations existing in the clay after ion-exchange. The solvent which can be used as the first polar solvent varies depending on the kind of the clay to be used and, for example, water, acetonitrile or alcohols may be preferable. Ethanol, methanol, propanol and isopropanol are preferable as alcohols. These first polar solvents may be used alone or in combination.

When a mixture of water and the above solvent other than water is used as the first polar solvent, a mass ratio of water to the above solvent other than water is preferably within a range from 90/10 to 10/90, and more preferably from 60/40 to 40/60.

When the amount of the above solvent other than water is too small, sufficient washing effect of removing hydrophilic ions cannot be obtained and thus the washing operation must be repeated over the enormous length of time. Also in cases where a tetraphenylphosphonium-modified clay in a state of containing the first polar solvent obtained in the below-mentioned second step is uniformly dispersed in the second polar solvent to obtain a clay dispersion liquid, and clay aggregation may occur, thus making it difficult to obtain a uniform dispersion.

### (Second Polar Solvent)

There is no particular limitation on the second polar solvent used in the present invention, as long as it is excellent in dispersibility of a tetraphenylphosphonium-modified clay. The second polar solvent varies depending on the kind of the clay constituting the tetraphenylphosphonium-modified clay, and preferably has a high boiling point. Water, N,N-dimethylformamide, dimethylacetamide, dimethyl sulfoxide and 1-methyl-2-pyrrolidone are particularly preferable. These second polar solvents may be used alone or in combination.

The second polar solvent may be a solvent which is excellent in dispersibility (less aggregation) of the solvent as compared with the first polar solvent.

### (Method for Producing Clay Dispersion Liquid)

The method for producing a clay dispersion liquid of the present invention includes the first step of dispersing clay in a liquid containing water as a main component to obtain a dispersion; the second step of introducuing tetraphenylphosphonium ions into a liquid containing the clay dispersed therein to thereby perform ion-exchange between hydrophilic cations existing in the clay and the tetraphenylphosphonium ions to obtain a tetraphenylphosphonium-modified clay, and adding a first polar solvent to the tetraphenylphosphonium-modified clay to thereby remove the by-produced electrolyte to obtain a dispersion containing the first polar solvent; and the third step of adding a second polar solvent to the tetraphenylphosphonium-modified clay in the dispersion containing the first polar solvent to thereby disperse the tetraphenylphosphonium-modified clay in a mixed solvent of the first and second polar solvents to obtain a clay dispersion liquid.

### (First Step)

In the first step, clay is dispersed in a liquid containing water as a main component. Herein, the liquid containing water as a main component is a liquid containing water such as ion-exchange water or distilled water in the amount of 50% by mass or more. The liquid may be entirely only water. The liquid may contain, in addition to water, an organic solvent which can be mixed with water in any ratio. Specifically, the liquid may optionally contain acetonitrile, dimethylformamide, dimethylacetamide, 1-methyl-2-pyrrolidone, and/or alcohol. The amount of the liquid containing water as a main component is preferably from 200 to 200,000 parts by mass, and more preferably from 1,000 to 100,000 parts by mass, based on 100 parts by mass of a swelling clay. In order to disperse the clay in these liquid, it is possible to use ordinary stirrers such as a rotary stirrer, and a shaking stirrer.

It is more preferred to heat in case of dispersing. It becomes possible to efficiently disperse the clay by stirring while heating within a range from 50 to 80° C.

### (Second Step)

In the second step, tetraphenylphosphonium ions are introduced into the dispersion obtained in the first step to thereby ion-exchange between hydrophilic cations exiting in the clay and the tetraphosphonium ions to obtain a tetraphenylphosphonium-modified clay; and then a first polar solvent is added to the tetraphosphonium clay to thereby remove the by-produced electrolyte to obtain a dispersion containing the first polar solvent.

The clay used in the present invention is clay in which flaky particles of an inorganic compound can be oriented in a layered form. Hydrophilic cations typified by sodium ions exist in the clay. This cation can be ion-exchanged with other cations. Then, ion-exchange is carried out using tetraphenylphosphonium ions to thereby eliminate hydrophilicity from the clay to obtain a tetraphenylphosphonium-modified clay which can be dispersed in a solvent (for example, the first polar solvent, the second polar solvent, and so on).

According to the ion-exchange method, the clay is sufficiently dispersed in the liquid containing water as a main component in the first step, and then tetraphenylphosphonium ions are added, followed by stirring using an ordinary stirrer such as a rotary stirrer until a uniform dispersion is obtained to obtain a tetraphenylphosphonium-modified clay. At this time, tetraphenylphosphonium ions are preferably added in the amount of about 1 to 10 times the ion exchange capacity of the clay, and more preferably about 1 to 5 times. When the amount of tetraphenylphosphonium ions exceeds 10 times the ion exchange capacity of the clay, an organic substance is excessively incorporated into a clay film, and thermolysis characteristics of the thus formed clay film are likely to deteriorate. In contrast, when the amount of tetraphenylphosphonium ions is less than 1 time the ion exchange capacity of the clay, the ion-exchange cannot be sufficiently carried out, and thus hydrophilic ions such as sodium ions remain on at least one of a surface of the clay or in the space between layers of the clay, and it is difficult to obtain sufficient hydrophobicity when the clay film is formed. As used herein, the term “ion exchange capacity” can be expressed by the milligram equivalent (meq) of all the exchangeable cations which are preserved in 100 g of a dry clay, and can be measured by the ammonium nitrate solution leaching method or the methylene blue adsorption method. It is also possible to represent “meq/100 g” by “cmol(+)/kg”.

The tetraphenylphosphonium-modified clay formed by stirring is naturally sedimented and then the supernatant liquid containing hydrophilic ions is separated. Examples of the method of removing the supernatant liquid include centrifugal separation and suction filtration method.

To 10 parts by mass of the tetraphenylphosphonium-modified clay from which the supernatant liquid is removed, 1000 to 10,000 parts by mass of a first polar solvent was added, followed by stirring. Subsequently, the tetraphenylphosphonium-modified clay formed is sedimented again to thereby remove the supernatant liquid. The tetraphenylphosphonium-modified clay is washed by optionally repeating this operation once or several times until the concentration of hydrophilic ions in the supernatant liquid becomes 100 ppm or less, preferably 10 ppm or less, and more preferably 1 ppm or less. Another method may be used as long as the concentration of hydrophilic ions can be adjusted within the above range. For example, it is also possible to use a continuous washing method in which washing water is continuously poured while performing centrifugal separation or suction filtration, in addition to the above-mentioned method in which decantation is repeated.

In case the concentration of hydrophilic ions is not adjusted to 100 ppm or less, it is difficult to obtain hydrophobicity when the clay dispersion liquid is formed into a clay film, and therefore it is not preferable.

### (Third Step)

In the third step, a second polar solvent is added to the tetraphenylphosphonium-modified clay in the dispersion containing the first polar solvent to thereby disperse the tetraphenylphosphonium-modified clay in the mixed solvent of the first and second polar solvents and water to obtain a clay dispersion liquid of the present invention. That is, it is a feature that the clay dispersion liquid is obtained without the drying step which is required in the below-mentioned prior art.

Usually, the clay dispersion liquid is obtained by the below-mentioned method. That is, the obtained organically modified clay is dried to completely remove moisture from the clay to obtain a solid component, and then the solid component is ground to obtain a clay powder. Subsequently, the obtained clay powder is added to an organic solvent to thereby expand (swell) the clay powder to obtain a clay dispersion liquid.

In case of such a conventional method, in order to make it possible to expand the clay powder in the organic solvent, ions having a large carbon content, for example, a quaternary ammonium salt such as a dimethyl distearyl ammonium salt or a trimethyl stearyl ammonium salt was used as organic onium ions in case of ion-exchange for the following reason. That is, when the carbon content in the organic onium ions decreases, swelling of the clay in the solvent becomes poor and thus a sufficient dispersion cannot be obtained. However, since the ions having a large carbon content, for example, a quaternary ammonium salt such as a dimethyl distearyl ammonium salt or a trimethyl stearyl ammonium salt have poor heat resistance, only a clay film having poor heat resistance was obtained from a conventional clay dispersion liquid.

It is the feature of the present invention that a clay dispersion liquid can be obtained without the drying step which is required in the above-mentioned prior art. Specifically, in the present invention, the tetraphenylphosphonium-modified clay containing the first polar solvent obtained in the second step is added to the second polar solvent as it is. Then, the tetraphenylphosphonium-modified clay is swelled and dispersed in the mixed solution of the first and second polar solvents to obtain a clay dispersion liquid of the present invention. There is no particular limitation on the second polar solvent, as long as the tetraphenylphosphonium-modified clay is dispersed therein. Preferably, N,N-dimethylformamide, dimethylacetamide, dimethyl sulfoxide and 1-methyl-2-pyrrolidone are used. In order to obtain a dispersion state and desired viscosity of the dispersion, water can also be added as the second polar solvent. At this time, the amount of the second polar solvent is preferably from 50 to 10,000 parts by mass, and more preferably from 500 to 1,000 parts by mass, based on 100 parts by mass of the tetraphenylphosphonium-modified clay. When the amount of the second polar solvent is more than 10,000 parts by mass, the solid content decreases and optimum viscosity for the present invention of the dispersion cannot be obtained, and thus it may become difficult to form a film. In contrast, when the amount is less than 50 parts by mass, the tetraphenylphosphonium-modified clay is not sufficiently dispersed and the viscosity becomes very high, and thus it may become difficult to form a uniform clay film.

### (Film Formation)

The feature of a clay film of the present invention is that the clay film is obtained by applying the clay dispersion liquid obtained by the above-mentioned method on a base material or pouring the clay dispersion liquid into a container, and then removing a liquid containing, as a main component, a polar solvent containing water in the clay dispersion liquid to form a film. The clay film of the present invention can have any surface shape.

There is no particular limitation on the base material used to from a clay film having a flat surface, as long as it has a flat surface and does not cause deformation at a clay drying temperature and also enables easy removal of the clay film after drying, and the base material can be optionally selected. Among the base materials, a polyethylene terephthalate film, which is comparatively inexpensive and is easy to use, is preferably used as the base material. On the other hand, a container coated with a fluororesin is preferably used as the container. It is also possible to use a composited member of a clay film and another member. Specifically, the step of applying or dipping of the clay dispersion liquid of the present invention is subjected on the member to be composited and then the solvent is removed by drying, and thus making it possible to obtain a composite member in which a clay film is formed on any member. There is no particular limitation on the shape of the member to be composited. Even when the member to be composited has a complicated shape having a curved surface, a clay film can be formed if the clay dispersion liquid can penetrate thereunto, and thus it becomes possible to composite the member.

It is not necessarily required for the base material used in formation of a clay film having no flat surface and to cause no deformation at the clay drying temperature. When the base material having no flat surface is used for formation of a clay film, a surface shape (for example, uneven shape) of the base material is transferred onto a surface of the clay film and thus an anti-glare clay film can be formed.

Specific examples of the method of forming a clay film are described below. First, the clay dispersion liquid obtained by the method of the present invention is applied on a base material using an applicator or the like, or poured in a container. Subsequently, this dispersion is preferably dried using a hot-air circulation type electric dryer or the like to thereby remove a dispersion medium (liquid containing, as a main component, a polar solvent containing water) in the dispersion to obtain a clay film on the base material, container or supporting body. The thickness of a clay dispersion liquid to be applied or poured is preferably from 100 to 5,000 μm. The preferable range of the thickness of the clay dispersion liquid varies depending on the concentration of the solid component of a coatin material, and the thickness of a film formed after drying is preferably from 10 to 200 μm. When the thickness of the film after drying is 10 μm or more, it is possible to use it as an independent film after drying. When the film thickness is less than 10 μm, the mechanical strength of the film decreases and thus the film is likely to cause fracture. The upper limit of the thickness may be selected according to the characteristics required. The clay film in the present invention also includes “plate” which has a larger thickness than that of the “film”.

The content of a tetraphenylphosphonium-modified clay component in the obtained clay film is preferably 70% by mass or more, and more preferably 80% by mass or more. The amount of the solid component of the coating material may also be 100% by mass. When the amount of the clay component is less than 70% by mass, characteristics peculiar to the clay, such as heat resistance, low liner expansion property and gas barrier property may deteriorate.

The clay film of the present invention is inferior in water absorptivity and hygroscopicity since a tetraphenylphosphonium -modified clay is used, and the moisture absorption rate at 40° C. and a relative humidity of 90% is less than 5%.

The obtained clay film has the mechanical strength which enables use as an independent film after removal from the base material. Furthermore, the clay film of the present invention is prepared by mixing two or more kinds of synthetic clays, and thus making it possible to obtain a transparent material which has high transparency and is also excellent in flexibility. Examples of the synthetic clay include a synthetic saponite and a synthetic hectorite. The amount of tetraphenylphosphonium ions in the tetraphenylphosphonium-modified clay is desirably less than 30% by weight.

The method for producing a transparent material of the present invention is the same as that of the clay film.

The transparent material of the present invention can be easily cut into any size and shape such as circle, square or rectangle using scissors, cutter or the like.

The thickness of the transparent material of the present invention is preferably less than 1 mm, and the area is preferably more than 1 cm².

Regarding light transmission properties of the transparent material of the present invention, light transmittance of visible light (at a wavelength of 500 nm) is 80% or more and light transmittance of visible light after a heat treatment at 400° C. is 70% or more, and the area can be increased to a large area of 100 cm×40 cm or more. The transparent material has flexibility which enables no occurrence of cracks at a bend radius of 4 mm, and also has water resistance in which the moisture absorption rate at 40° C. and a relative humidity of 90% is less than 5%.

Therefore, the transparent material of the present invention can be used for a film substrate for liquid crystal or organic EL display, a substrate for an electronic paper, a sealing film for an electronic device, a lens film, a film for a light guide, a prism film, a film for a phase difference plate or a polarizer, a viewing angle correction film, a film for PDP, a film for LED, a member for optical communication, a film for a touch panel, a substrate for various functional films, a film for an electric equipment which has structure wherein the interior thereof can be shown through such as transparent structure, a film for optical recording media such as a video disk, CD, CD-R, CD-RW, DVD, MO, MD, a phase change disk and an optical card, a sealing film for a fuel cell and a film for a solar cell. A clay film having no transparency can be used for a material for industrial equipment such as a seal material, a packing material, a gasket material, a gas barrier material, a substrate for electronic circuit, a flame retardant sheet or a radiating member. The clay film can also be used as a composite material combined with any member, not as a self-reliance film.

The clay film and transparent material of the present invention can also be used as an independent film alone. However, on one surface or both surfaces of the clay film, a single layer or plural layers of at least one of an inorganic thin film and an organic thin film can be formed in order to obtain excellent gas barrier properties, chemical resistance, surface smoothness and the like.

There is no particular limitation on the type of film to be layered on the clay film and the transparent material of the present invention, and an optimum one can be selected according to applications. For example, high gas barrier properties and chemical resistance can be imparted by forming a silicon oxide (SiOx) or silicon nitride oxide, as an inorganic thin film, on a clay film using a sputtering method or a plasma CVD method.

It is also possible to impart flastness to a surface by applying an organic polymer, as an organic thin film, on the clay film. It is also possible to impart hard coating properties by laminating a hard coat layer. It is possible to obtain characteristics, which cannot be obtained by the clay film alone, by laminating these inorganic and organic thin films on a surface of the clay film.

It is considered that the roll-to-roll process can also be applied to the clay film and transparent material of the present invention because of excellent flexibility and processability.

The clay dispersion liquid of the present invention can contain various common additives such as a resin, a curing aid, an antioxidant, a surfactant, a pigment and a leveling agent. It becomes possible to adjust the characteristics of the clay dispersion liquid, such as viscosity, solid content and the like, by adding these additives. An additive component is contained in the clay film and transparent material obtained using a clay dispersion liquid containing additives added therein, and the additive component may sometimes exert an influence on an improvement in characteristics of the clay film and transparent material. For example, the addition of the resin may sometimes improve the strength of the clay film and the transparent material or impart flexibility thereto.

In the present invention, in case of swelling a tetraphenylphosphonium-modified clay and dispersing the swelled clay in an organic solvent, when the dry step in a conventional production method is omitted and also a polar solvent is used as an organic solvent, it became possible to disperse tetraphenylphosphonium-modified clay which cannot be swollen and dispersed by a conventional method, and thus obtaining a tetraphenylphosphonium-modified clay dispersion liquid. Use of the tetraphenylphosphonium-modified clay dispersion liquid made it possible to obtain a clay film having excellent heat resistance and water resistance.

### EXAMPLES

The present invention will be specifically described below by way of Examples, but the present invention is not limited thereto. Additions, omissions, substitutions, and other modifications of the constitution can be made without departing from the spirit or scope of the present invention.

The respective physical properties of Examples and Comparative Examples were measured by the methods shown below.

### [Thermo Gravimetry/Differential Thermal Analysis (TG-DTA Analysis)]

Weight variation was measured in air while the temperature was raised within a range from room temperature to 600° C. at a rate of 5° C. per minute using an analyzer (manufactured by Seiko Instruments Inc. under the trade name of EXSTAR6000 STATION, Model Number: TG/DTA6200). The change rate (DTG) of the weight variation was plotted for each temperature, and the point of inflection was determined as a decomposition temperature.

### Example 1

10 g of natural purified montmorillonite (manufactured by KUNIMINE INDUSTRIES CO., LTD. under the trade name of KUNIPIA G) as clay was added in 1,000 g of distilled water, and dispersed and swelled by a magnetic stirrer while heating at a temperature of 70° C. to obtain a dispersion.

Subsequently, 10 g of a commercially available tetraphenylphosphonium bromide (manufactured by Wako Pure Chemical Industries, Ltd.) was added to the dispersion, followed by further stirring for 2 hours. Thereafter, solid-liquid separation was carried out by a centrifugal separator at 6,000 rotations for 10 minutes. The separated supernatant was removed, and then a mixed solution of distilled water/ethanol in a mixing ratio of 50/50 was added so that the total weight became 500 cm³, followed by stirring. After stirring, solid-liquid separation was carried out again by the centrifugal separator under the above conditions and then the separated supernatant was removed again. The operation of stirring and centrifugal separation was repeatedly carried out until the concentration of sodium ions in the supernatant becomes 1 ppm or less. The solid substance obtained by the above operation was a gel-like tetraphenylphosphonium-modified clay containing water and ethanol (a solid content of 10%).

Next, 60 g of N,N-dimethylformamide was added to 40 g of the obtained gel-like tetraphenylphosphonium-modified clay containing water and ethanol (solid content of 10%), followed by stirring at 5,000 rpm for 60 minutes using ACE Homogenizer “AM-001” (manufactured by NISSEI Corporation) to obtain a uniform clay dispersion liquid.

Next, bubbles in the clay dispersion liquid were removed by evacuating in a vacuum dryer and the clay dispersion liquid was applied on PET (manufactured by Unitika, Ltd. under the trade name of EMBLET) in the form of a film using an applicator. After drying in a forced air oven under the temperature condition at 100° C. for 1 hour, the formed film was separated from PET to obtain a clay film having a thickness of about 40 micrometers.

### Example 2

In the same manner, except that a synthetic saponite (manufactured by KUNIMINE INDUSTRIES CO., LTD. under the trade name of SUMECTON SA) was used in place of the clay used in Example 1, a uniform clay dispersion liquid was obtained.

Next, in the same manner as in Example 1, a clay film having a thickness of about 40 micrometers was obtained.

### Example 3

In the same manner, except that a synthetic hectorite (manufactured by RoockWood Additives Limited. under the trade name of LAPONITE 5482) was used in place of the clay used in Example 1, a uniform clay dispersion liquid was obtained.

Next, in the same manner as in Example 1, a clay film having a thickness of about 40 micrometers was obtained.

### Example 4

In the same manner, except that a mixed clay of 4 g of a synthetic saponite (manufactured by KUNIMINE INDUSTRIES CO., LTD. under the trade name of SUMECTON SA) and 6 g of a synthetic hectorite (manufactured by RoockWood Additives Limited. under the trade name of LAPONITE 5482) was used in place of the clay used in Example 1, a uniform clay dispersion liquid was obtained.

Next, in the same manner as in Example 1, a clay film having a thickness of about 40 micrometers was obtained.

### Comparative Example 1

In the same manner, except that tetraphenylphosphonium bromide used in Example 1 was replaced by methylethylimidazolium bromide (manufactured by The Nippon Synthetic Chemical Industry Co., Ltd.), a uniform clay dispersion liquid was obtained.

Next, in the same manner as in Example 1, a clay film having a thickness of about 40 micrometers was obtained.

### Comparative Example 2

In the same manner, except that tetraphenylphosphonium bromide used in Example 1 was replaced by tetramethylammonium bromide (manufactured by Wako Pure Chemical Industries, Ltd.), a uniform clay dispersion liquid was obtained.

Next, in the same manner as in Example 1, a clay film having a thickness of about 40 micrometers was obtained.

### Comparative Example 3

The gel-like tetraphenylphosphonium-modified clay containing water and ethanol (solid content of 10%) obtained by adding a mixed solution of distilled water/ethanol in a mixing ratio of 50/50 and repeating stirring and centrifugal separation in Example 1 was dried at 110° C. until the water content became 0.1%. Subsequently, the dried material was ground to the size of about 50 micrometers by a cutter mill to obtain a clay solid. Then, 18 g of distilled water, 18 g of ethanol and 60 g of N,N-dimethylformamide were added to 4 g of the obtained clay solid, followed by stirring at 5,000 rpm for 60 minutes using ACE Homogenizer “AM-001” (manufactured by NISSEI Corporation). However, masses existed and thus a uniform clay dispersion liquid could not be obtained.

Next, in the same manner as in Example 1, a film was intended to form. However, a lot of clay masses existed and thus a uniform clay film could not be obtained.

### Comparative Example 4

5 g of a natural purified montmorillonite (manufactured by KUNIMINE INDUSTRIES CO., LTD. under the trade name of KUNIPIA G) was added in 100 g of ion-exchange water and then dispersed at 7,000 rpm for 30 minutes using a homogenizer. As a result, a brown uniform solution was obtained. In the same manner as in Example 1, a clay film having a thickness of about 40 micrometers was obtained using the obtained clay dispersion liquid. This clay film was cut into pieces measuring 5 cm by 5 cm, immersed in 200 cc of ion-exchange water for 1 hour and then taken out from ion-exchange water using tweezers. As a result, the clay film was scattered and thus the film could not hold the shape before immersion.

The clay films obtained in Examples and Comparative Examples were respectively evaluated in Table 1. The results are shown in Table 1.

TABLE 1

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Clay | Kunipia G (natural | ◯ | | | | ◯ | ◯ |
| | montmorillonite) | | | | | | |
| | Sumecton SA | | ◯ | | ◯ | | |
| | (synthetic saponite) | | | | | | |
| | Laponite S482 | | | ◯ | ◯ | | |
| | (synthetic hectorite) | | | | | | |
| Organizer | Tetraphenyl- | ◯ | ◯ | ◯ | ◯ | | |
| | phosphonium | | | | | | |
| | Methylethyl- | | | | | ◯ | |
| | imidazolium | | | | | | |
| | bromide | | | | | | |
| | Tetramethyl- | | | | | | ◯ |
| | ammonium bromide | | | | | | |
| Heat | Temperature at | 350° C. | 350° C. | 350° C. | 350° C. | 300° C. | 220° C. |
| Resistance | which | | | | | | |
| | decomposition starts | | | | | | |
| | as determined by | | | | | | |
| | TG-DTA | | | | | | |

As is apparent from the above table, the clay films of the respective Examples produced using the clay dispersion liquid of the present invention had heat resistance (350° C. or higher) exceeding 300° C. which was the limit of heat resistance in a conventional clay film. The clay films of the respective Examples had heat resistance exceeding 300° C., and also had water resistance.

### Example 5

60 g of N,N-dimethylformamide was added to 40 g of the gel-like tetraphenylphosphonium-modified clay prepared in Example 1, and then charged in closed container made of a plastic, together with a TEFLON® rotator, followed by vigorously shaking at 25° C. for 2 hours to obtain a uniform dispersion. Then, this dispersion was deaerated by a vacuum deaerator. Subsequently, this dispersion was applied onto a metal plate with a 2 mm thick polypropylene film mounted thereon. A scraper made of stainless steel was used for application. Using a spacer as a guide, a clay paste film having a uniform thickness was formed. A tray was air-dried at room temperature to obtain a uniform transparent material having a thickness of about 40 micrometers. The thus formed modified clay film was separated from the tray to obtain an independent transparent material (TPP-SA) having excellent flexibility.

### Characteristics of Transparent Material

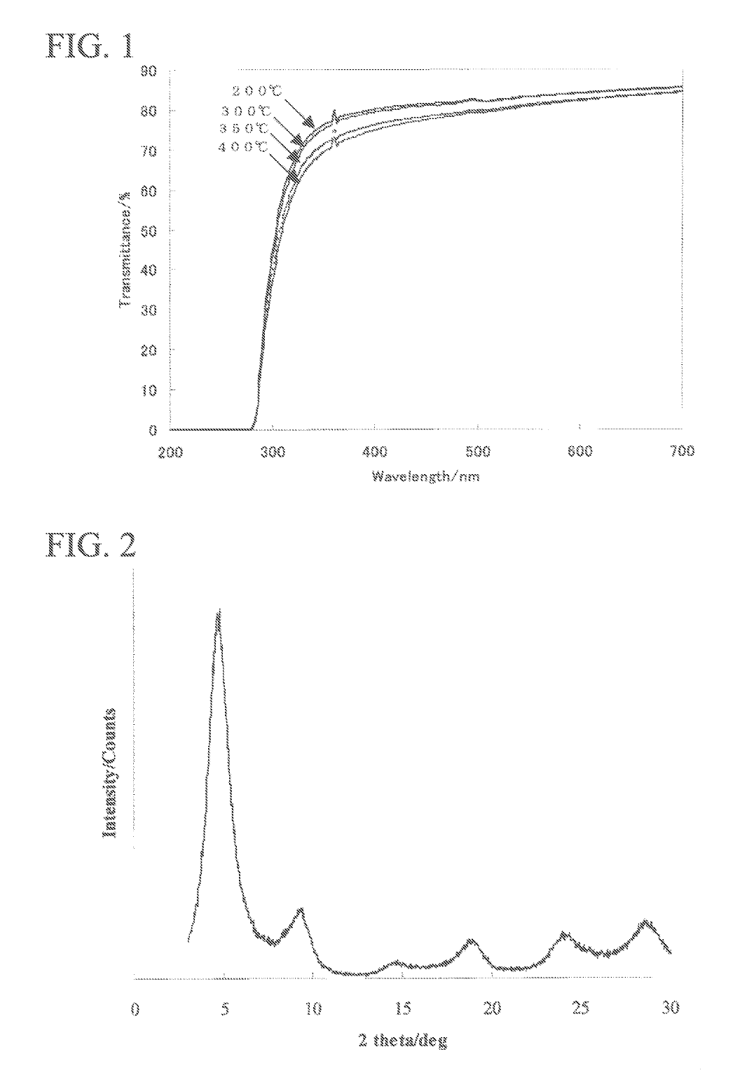

Flexibility of TPP-SA was evaluated based on a mandrel test of JIS K5600-5-1. As a result, cracks were not generated even when bent at a radius of 4 mm, and no defect was formed. A light transmittance at a wavelength of 500 nm, measured by a visible-ultraviolet spectrophotometer, of this film was 82%. The light transmittance after heating at about 400° C. was 78% (FIG. 1). A total light transmittance based on JIS K7105: 1981 “Method for Testing Optical Characteristics” of this film was 90% and Haze value was 50%.

### Water Resistance of Transparent Material

TPP-SA was immersed in distilled water for 24 hours. After this treatment, abnormalities such as pinhole and cracks were not visually observed. After drying overnight at 110° C., a transparent material was cut into pieces measuring 2 cm by 2 cm and placed in an oven at 40° C. and a relative humidity of 90%. After 24 hours, the weight variation of the transparent material was 5% or less.

### Structure of Transparent Material

An X-ray diffraction chart of TPP-SA is shown in FIG. 2. In this X-ray diffraction chart, a remarkably sharp bottom reflection peak 001 was observed and interlayer spacing calculated from the angle was as follows: d=1.88 nm. In addition, another sharp high peak is observed at d=9.40(002). Therefore, it is apparent that clay layered crystals are oriented and layered in TPP-SA.

Thermal analysis (at a temperature rise rate of 5° C. per minute, under atmospheric condition) of TPP-SA was carried out. Weight loss due to dehydration of adsorbed water was observed from a TG curved line within a range of from room temperature to 200° C. Weight loss (about 20%) involved in thermolysis of an organic substance was observed within a range of from 350° C. to 650° C.

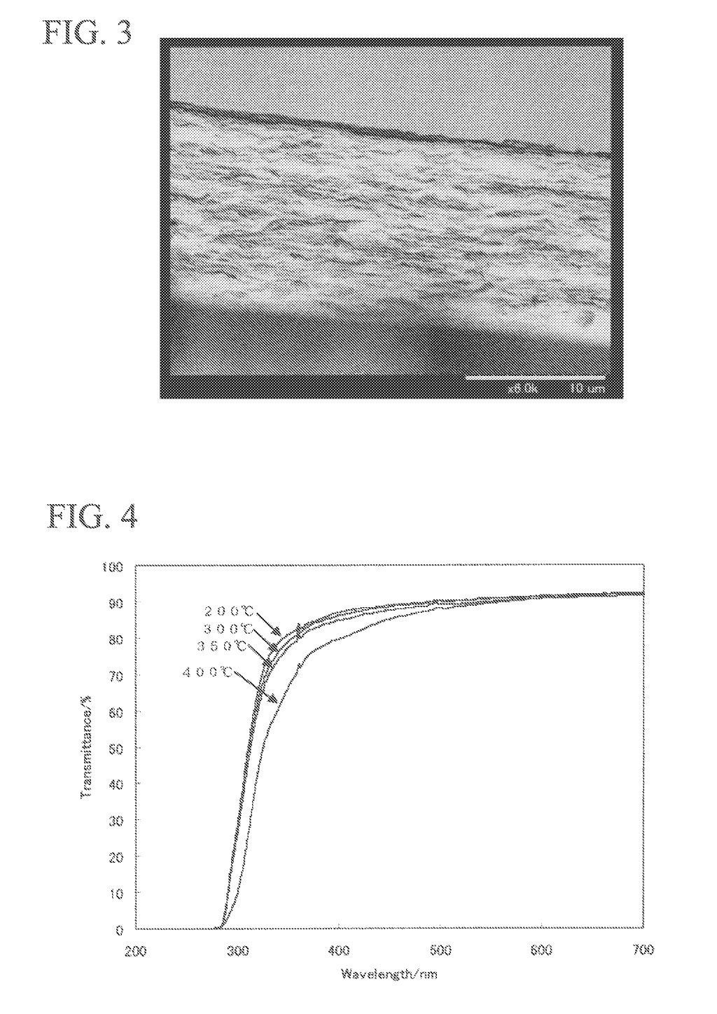

A scanning electron micrograph of a cross section of TPP-SA is shown in FIG. 3. It is apparent that a tetraphenylphosphonium-modified clay has a structure in which plate crystals are oriented and layered in parallel to a film. It is considered that this structure contributes to flexibility and transparency of the transparent material.

### Heat Resistance of Transparent Material

TPP-SA was heated by an electric furnace. The temperature was raised from room temperature to each temperature of 200° C., 300° C., 350° C. and 400° C. at a temperature rise rate of 5° C. per minute under atmospheric conditions. Immediately after reaching a predetermined temperature, TPP-SA was taken out from the electric furnace and was quickly left standing to cool to room temperature. After this heat treatment, abnormality such as occurrence of pinhole and cracks was not visually observed. It was also apparent that, after a heat treatment at each temperature, a light transmittance at a wavelength of 500 nm of a TPP-SA film becomes 82% (200° C.), 82% (300° C.), 80% (350° C.) and 78% (400° C.), respectively, and the film shows a high light transmittance such as 70% or more even at 400° C. (FIG. 1)

### Example 6

### Production of Tetraphenylphosphonium-Modified Clay

After mixing 4 g of a synthetic saponite (manufactured by KUNIMINE INDUSTRIES CO., LTD. under the trade name of SUMECTON SA) and 6 g of a synthetic hectorite (manufactured by RoockWood Additives Limited. under the trade name of LAPONITE S482), the obtained mixture was dispersed in 1,000 cm³ of distilled water. Next, this dispersion was mixed with 10 g of a commercially available tetraphenylphosphonium bromide guaranteed reagent, followed by stirring using a homogenizer for 2 hours to prepare a uniform dispersion. This dispersion was subjected to solid-liquid separation at 6,000 rpm for 10 minutes, using a centrifugal separator. After removing the separated supernatant, a mixed solution of distilled water/ethanol in a mixing ratio of 50/50 was added so that the total amount became 500 cm³, followed by stirring. After stirring, solid-liquid separation was carried out again under the same condition using a centrifugal separator to remove again the separated supernatant. The operation of stirring and centrifugal separation was repeatedly carried out until the concentration of sodium ions in the supernatant becomes 1 ppm or less. The solid substance obtained by the above operation was a gel-like tetraphenylphosphonium-modified clay containing water and ethanol (with a solid content of 10%).

### Production of Transparent Material

60 g of N,N-dimethylformamide was added to 40 g of the gel-like tetraphenylphosphonium-modified clay obtained above, and then charged in closed container made of a plastic, together with a TEFLON® rotator, followed by vigorously shaking at 25° C. for 2 hours to obtain a uniform dispersion. Then, this dispersion was deaerated by a vacuum deaerator. Subsequently, this dispersion was applied onto a metal plate with a 2 mm thick polypropylene film mounted thereon. A scraper made of stainless steel was used for application. Using a spacer as a guide, a clay paste film having a uniform thickness was formed. A tray was air-dried at room temperature to obtain a uniform transparent material having a thickness of about 40 micrometers. The thus formed modified clay film was separated from the tray to obtain an independent transparent material (TPP-HE-SA) having excellent flexibility.

### Characteristics of Transparent Material

Flexibility of TPP-HE-SA was evaluated based on a mandrel test of JIS K5600-5-1. As a result, cracks were not generated even when bent at a radius of 4 mm, and no defect was formed.

A light transmittance at a wavelength of 500 nm, measured by a visible-ultraviolet spectrophotometer, of this film was 91%. The light transmittance after heating at about 400° C. was 88% (FIG. 4). A total light transmittance based on JIS K7105: 1981 “Method for Testing Optical Characteristics” of this film was 91% and Haze value was 12%.

### Water Resistance of Transparent Material

TPP-HE-SA was immersed in distilled water for 24 hours. After this treatment, abnormalities such as pinhole and cracks were not visually observed. After drying overnight at 110° C., a transparent material was cut into pieces measuring 2 cm by 2 cm and placed in an oven at 40° C. with a relative humidity of 90%. After 24 hours, weight variation of the transparent material was 5% or less.

### Structure of Transparent Material

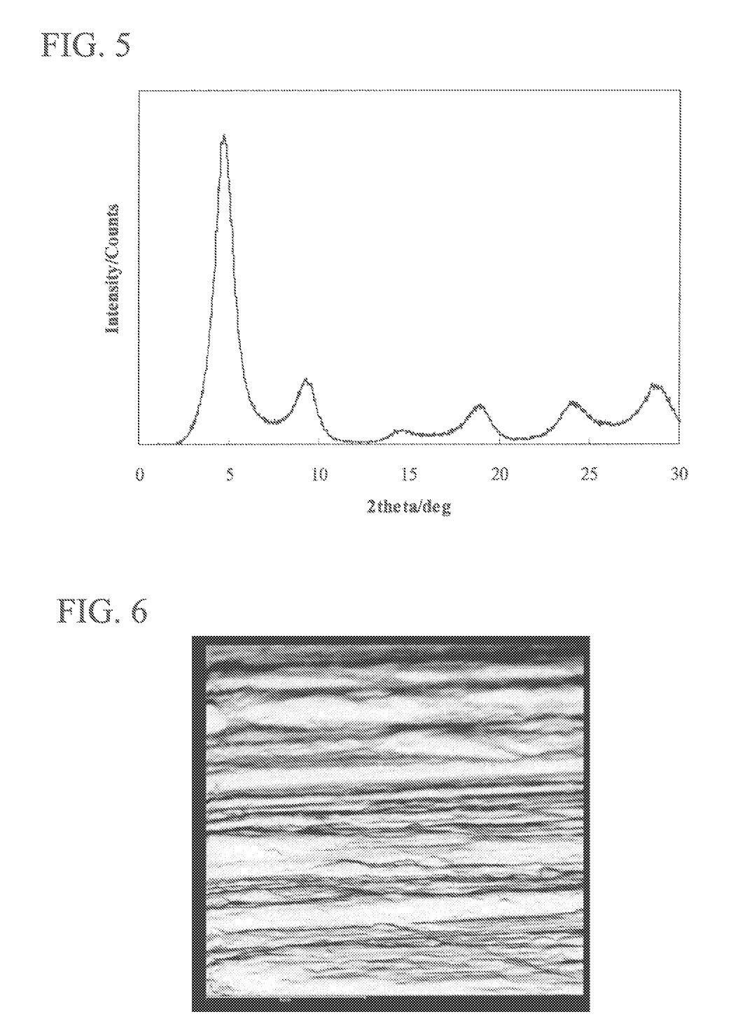

An X-ray diffraction chart of TPP-HE-SA is shown in FIG. 5. In this X-ray diffraction chart, a remarkably sharp bottom reflection peak 001 was observed and interlayer spacing calculated from the angle was as follows: d=1.87 nm. In addition, another sharp high peak is observed at d=9.55(002). Therefore, it is apparent that clay layered crystals are oriented in TPP-SA-HE.

Thermal analysis (at a temperature rise rate of 5° C. per minute, under atmospheric condition) of TPP-HE-SA was carried out. Weight loss due to dehydration of adsorbed water was observed from a TG curved line within a range from room temperature to 200° C. Weight loss (about 20%) involved in thermolysis of an organic substance was observed within a range of from 350° C. to 650° C.

A scanning electron micrograph of a cross section of TPP-HE-SA is shown in FIG. 6. It is apparent that a tetraphenylphosphonium-modified clay has a structure in which plate crystals are oriented and layered in parallel to a film. It is considered that this structure contributes to flexibility and transparency of the transparent material.

### Heat Resistance of Transparent Material

TPP-HE-SA was heated by an electric furnace. The temperature was raised from room temperature to each temperature of 200° C., 300° C., 350° C. and 400° C. at a temperature rise rate of 5° C. per minute under atmospheric condition. Immediately after reaching a predetermined temperature, TPP-HE-SA was taken out from the electric furnace and was quickly left standing to cool to room temperature. After this heat treatment, abnormality such as occurrence of pinhole and cracks was not visually observed. It was also apparent that, after a heat treatment at each temperature, a light transmittance at a wavelength of 500 nm of a TPP-HE-SA film becomes 90% (200° C.), 90% (300° C.), 89% (350° C.) and 88% (400° C.), respectively, and the film shows a high light transmittance of, for example, 70% or more even at 400° C. (FIG. 4)

### Example 7

In the same manner, except that 3 g of a synthetic saponite (manufactured by

KUNIMINE INDUSTRIES CO., LTD. under the trade name of SUMECTON SA) and 7 g of a synthetic hectorite (manufactured by RoockWood Additives Ltd. under the trade name of LAPONITE 5482) were used at the time of producing the tetraphenylphosphonium-modified clay in Example 6, a uniform transparent material having a thickness of about 40 micrometers was obtained.

### Example 8

In the same manner, except that 5 g of a synthetic saponite (manufactured by KUNIMINE INDUSTRIES CO., LTD. under the trade name of SUMECTON SA) and 5 g of a synthetic hectorite (manufactured by RoockWood Additives Ltd. under the trade name of LAPONITE 5482) were used at the time of producing the tetraphenylphosphonium-modified clay in Example 6, a uniform transparent material having a thickness of about 40 micrometers was obtained.

### Example 9

In the same manner, except that 6 g of a synthetic saponite (manufactured by KUNIMINE INDUSTRIES CO., LTD. under the trade name of SUMECTON SA) and 4 g of a synthetic hectorite (manufactured by RoockWood Additives Ltd. under the trade name of LAPONITE S482) was used at the time of producing the tetraphenylphosphonium-modified clay in Example 6, a uniform transparent material having a thickness of about 40 micrometers was obtained.

With respect to the transparent materials thus produced in Examples 7 to 9, characteristics were measured in the same manner as in Examples 5 and 6. The results are shown in Table 2.

TABLE 2

| | Ex. 7 | Ex. 8 | Ex. 9 |
|---|---|---|---|
| Ease of Film | ◯ | ◯ | ◯ |
| Forming | | | |
| Transparency | ◯ | ◯ | ◯ |
| Total Light | 90 | 90 | 91 |
| Transmittance (%) | | | |
| HAZE (%) | ◯ (28) | ◯ (25) | ◯ (17) |
| Flexibility | ◯ | ◯ | ◯ |
| Water Resistance | ◯ | ◯ | ◯ |

As is apparent from the results of Examples 5 to 9, as compared with the transparent material produced from the tetraphenylphosphonium-modified clay in which only the synthetic saponite clay of Example 5 was ion-exchanged, regarding the transparent materials produced from the tetraphenylphosphonium-modified clay in which a synthetic clay mixture of two kinds of the synthetic saponite clay and the synthetic hectorite clay were ion-exchanged, like Examples 6 to 9, basic characteristics do not vary and HAZE reduces to about half, and the transparency thereof increases more.

### INDUSTRIAL APPLICABILITY

The clay dispersion liquid and clay film of the present invention can be used for a lot of products due to clay characteristics. For example, a clay film (transparent material) having transparency can be used for a film substrate for liquid crystal or organic EL display, a substrate for an electronic paper, a sealing film for an electronic device, a lens film, a film for a light guide, a prism film, a film for a retardation film or a polarizer, a viewing angle correction film, a film for PDP, a film for a LED, a member for optical communication, a film for a touch panel, a substrate for various functional films, a film for electric equipment which has structure wherein the interior thereof can be shown through, a film for optical recording media such as a video disk, CD, CD-R, CD-RW, DVD, MO, MD, a phase change disk and an optical card, a sealing film for a fuel cell and a film for a solar cell. A clay film having no transparency can be used for a material for industrial equipment such as a seal material, a packing material, a gasket material, a gas barrier material, a substrate for electronic circuit, a flame retardant sheet or a radiating member. The clay film can also be used as a composite material combined with any member, not as an independent film, and also can be used as a composite material which is further provided with heat resistance and a gas barrier property.

1. A clay dispersion liquid comprising:
a liquid containing, as a main component, a polar solvent containing water; and
a tetraphenylphosphonium-modified clay.

2. The clay dispersion liquid according to claim 1, which is obtained by:
introducing tetraphenylphosphonium ions into a liquid containing, as a main component, water containing a clay dispersed therein to thereby perform ion-exchange between hydrophilic cations existing in the clay and the tetraphenylphosphonium ions to obtain a tetraphenylphosphonium-modified clay;
adding a first polar solvent to the tetraphenylphosphonium-modified clay to thereby remove the by-produced electrolyte; and
adding a second polar solvent to the tetraphenylphosphonium-modified clay in a state of containing the first polar solvent to thereby disperse the tetraphenylphosphonium-modified clay.

3. The clay dispersion liquid according to claim 2, wherein the clays are one more kinds selected from the group consisting of kaolinite, dickite, halloysite, chrysotile, lizardite, amesite, pyrophyllite, talc, montmorillonite, beidellite, nontronite, stevensite, saponite, hectorite, sauconite, two-octahedron type vermiculite, three-octahedron type vermiculite, muscovite, paragonite, illite, sericite, phlogopite, biotite, lepidolite, magadiite, ilerite, kanemite and layered titanic acid.

4. The clay dispersion liquid according to claim 2, wherein the first polar solvent contains at least one of water, acetonitrile, ethanol, methanol, propanol and isopropanol.

5. The clay dispersion liquid according to claim 2, wherein the second polar solvent contains at least one of water, N,N-dimethylformamide, dimethylacetamide, dimethyl sulfoxide and 1-methyl-2-pyrrolidone.

6. A method for producing a clay dispersion liquid, which comprises:
the first step of dispersing clay in a liquid containing water as a main component to obtain a dispersion;
the second step of introducing tetraphenylphosphonium ions into the dispersion to thereby perform ion-exchange between hydrophilic cations existing in the clay and the tetraphenylphosphonium ions to obtain a tetraphenylphosphonium-modified clay, and adding a first polar solvent to the tetraphenylphosphonium-modified clay to thereby remove the by-produced electrolyte to obtain a dispersion containing the first polar solvent; and
the third step of adding a second polar solvent to the tetraphenylphosphonium-modified clay in the dispersion containing the first polar solvent to thereby disperse the tetraphenylphosphonium-modified clay in a mixed solvent of the first and second polar solvents to obtain a clay dispersion liquid.

7. A clay film which is obtained by:
applying the clay dispersion liquid according to any one of claims 1 to 5 onto a base material, or pouring the clay dispersion liquid into a container;
removing a liquid containing, as a main component, a polar solvent containing water in the clay dispersion liquid to form a film; and
removing the film from the base material or the container.

8. The clay film according to claim 7, wherein a moisture absorption rate at 40° C. and a relative humidity of 90% is less than 5%.

9. A method for producing a clay film, which comprises the steps of:
applying the clay dispersion liquid according to any one of claims 1 to 5 on a surface of a supporting body having a flat surface;
removing a dispersion medium in the dispersion to form a film on the supporting body; and
removing the film from the supporting body.

10. A transparent material comprising the clay film according to claim 7 or 8, wherein a total light transmittance (JIS K7105: 1981) is more than 80%.

11. The transparent material according to claim 10, wherein the light transmittance at 500 nm is 80% or more.

12. The transparent material according to claim 10, wherein the light transmittance at 500 nm is 70% or more after heating at 400° C. under atmospheric conditions.
